(19) United States
(12) Patent Application Publication
(10) Pub. No.: US 2017/0207921 A1
(43) Pub. Date: Jul. 20, 2017

(54) ACCESS TO A NODE

(71) Applicant: Nokia Technologies Oy, Espoo (FI)

(72) Inventors: Olli RANTAPUSKA, Vantaa (US); Raimo VUONNALA, Espoo (FI)

(21) Appl. No.: 15/326,454

(22) PCT Filed: Jul. 18, 2014
(86) PCT No.: PCT/FI2014/050584

§ 371 Date: Jan. 13, 2017

(51) Int. Cl. H04L 9/32; H04L 9/14; H04L 29/06; H04L 9/30; H04L 29/12; H04L 29/08

(52) U.S. Cl. CPC H04L 9/3263; H04L 61/1511; H04L 61/2514; H04L 61/2589; H04L 67/02; H04L 63/0272; H04L 63/166; H04L 63/029; H04L 9/30; H04L 9/14

(57) ABSTRACT

According to an example aspect of the present invention, there is provided an apparatus comprising at least one memory and the computer program code being configured to, with the at least one processing core, cause the apparatus at least to offer a network-based service, determine whether the apparatus is reachable from a public network, responsive to determining the apparatus is not reachable from the public network, establish a tunnel connection with a relay server, and participate in a cryptographic handshake with a network node, wherein packets comprised in the handshake are communicated via the tunnel connection

### FIELD OF INVENTION

The present invention relates to data networking.

### BACKGROUND OF INVENTION

Computer networking comprises that computers are enabled to communicate with each other via connections, which may comprise electrical leads suitably arranged between the computers. Computer networks comprising a large number of nodes may be arranged to use addressing systems, an example of which is the internet protocol, IP, addressing system. IP addressing works in IPv4 and IPv6 variants, wherein IPv4 is an earlier variant with a substantially smaller address space than the newer IPv6 variant.

To facilitate communication with a computer, or node, in an IP-based network the node may have a domain name system, DNS, name. A DNS name may be easier for humans to remember than an IP address, since an IP address consists of numbers and a DNS name may consist of words. For example, www.nokia.com is a DNS name whereas a corresponding IP address may be 92.122.67.80.

As the IPv4 addressing system has a limited number of addresses, these addresses have become a scarce resource. To overcome the shortage of IPv4 addresses, individual IPv4 addresses have been arranged to be shared between several nodes. The publicly accessible, shared, IPv4 address may in such systems be known as a public IP address, whereas nodes sharing a public IPv4 address may have secondary, private IP addresses that are valid only in a subnet under the node that is assigned the public IPv4 address.

Network address translation, NAT, is a technology that may be applied in joining subnets, based on private IP addresses and sharing a public IP address, to a public network.

Servers in a public network may be addressable using a DNS name or a public IP address of the server. It is therefore preferable to assign public IP addresses to nodes that are configured to act as servers. However, if individual consumers wish to operate nodes as servers, the scarcity of public IPv4 addresses may become a problem in that not all such nodes could be assigned a public IPv4 address.

### SUMMARY OF THE INVENTION

According to a first aspect of the present invention, there is provided an apparatus comprising at least one processing core, at least one memory including computer program code, the at least one memory and the computer program code being configured to, with the at least one processing core, cause the apparatus at least to offer a network-based service, determine whether the apparatus is reachable from a public network, responsive to determining the apparatus is not reachable from the public network, establish a tunnel connection with a relay server, and participate in a cryptographic handshake with a network node, wherein packets comprised in the handshake are communicated via the tunnel connection.

Various embodiments of the first aspect may comprise at least one feature from the following bulleted list:
the network-based service is associated with a domain name system name, and the apparatus stores a cryptographic certificate associated with the domain name system name and the cryptographic handshake is based at least in part on the cryptographic certificate
the at least one memory and the computer program code are configured to, with the at least one processing core, cause the apparatus to provide the network-based service to the network node after the cryptographic handshake is successfully completed
the cryptographic handshake comprises a transport layer security handshake
determining whether the apparatus is reachable from a public network comprises requesting an internet protocol address of the apparatus
the network-based service comprises a web service
the web service comprises a file sharing service
the tunnel connection comprises a virtual private network tunnel connection
establishing the tunnel connection comprises providing credentials of the apparatus to the relay node
the apparatus is configured to cause a domain name system name of the apparatus to become associated with an address of the relay server

According to a second aspect of the present invention, there is provided An apparatus comprising at least one processing core, at least one memory including computer program code, the at least one memory and the computer program code being configured to, with the at least one processing core, cause the apparatus at least to establish a tunnel connection with a node in a private network, receive an initial packet from a network node, the initial packet being addressed to an internet protocol address of the apparatus and comprising an indicator indicating an identifier of the node in the private network, and start relaying traffic between the node in the private network and the network node.

Various embodiments of the second aspect may comprise at least one feature from the following bulleted list:
the indicator comprises a server name indication in accordance with a transport layer security
the apparatus is configured to cause a domain name system name of the node in the private network to become associated with the apparatus
relaying traffic between the node in the private network and the network node comprises participating in establishing a first protocol connection to the network node, establishing, through the tunnel connection, a second protocol connection to the node in the private network and transparently relaying packets between the first and second protocol connections
the apparatus is not configured to attempt to decrypt traffic between the node in the private network and the network node
responsive to determining the first protocol connection is closed, the apparatus is configured to cause the second protocol connection to close

According to a third aspect of the present invention, there is provided a method, comprising offering a network-based service, determining whether an apparatus is reachable from a public network, responsive to determining the apparatus is not reachable from the public network, establishing a tunnel connection with a relay server, and participating in a cryptographic handshake with a network node, wherein packets comprised in the handshake are communicated via the tunnel connection.

Various embodiments of the third aspect may comprise at least one feature corresponding to a feature from the preceding bulleted list laid out in connection with the first aspect.

According to a fourth aspect of the present invention, there is provided a method comprising establishing a tunnel connection with a node in a private network, receiving an initial packet from a network node, the initial packet being addressed to an internet protocol address of an apparatus and comprising an indicator indicating an identifier of the node in the private network, and starting relaying of traffic between the node in the private network and the network node.

Various embodiments of the fourth aspect may comprise at least one feature corresponding to a feature from the preceding bulleted list laid out in connection with the second aspect.

According to a fifth aspect of the present invention, there is provided an apparatus comprising means for offering a network-based service, means for determining whether the apparatus is reachable from a public network, means for establishing a tunnel connection with a relay server responsive to determining the apparatus is not reachable from the public network, and means for participating in a cryptographic handshake with a network node, wherein packets comprised in the handshake are communicated via the tunnel connection.

According to a sixth aspect of the present invention, there is provided an apparatus, comprising means for establishing a tunnel connection with a node in a private network, means for receiving an initial packet from a network node, the initial packet being addressed to an internet protocol address of the apparatus and comprising an indicator indicating an identifier of the node in the private network, and means for starting relaying of traffic between the node in the private network and the network node.

According to a seventh aspect of the present invention, there is provided a non-transitory computer readable medium having stored thereon a set of computer readable instructions that, when executed by at least one processor, cause an apparatus to at least offer a network-based service, determine whether the apparatus is reachable from a public network, responsive to determining the apparatus is not reachable from the public network, establish a tunnel connection with a relay server, and participate in a cryptographic handshake with a network node, wherein packets comprised in the handshake are communicated via the tunnel connection

According to an eighth aspect of the present invention, there is provided a non-transitory computer readable medium having stored thereon a set of computer readable instructions that, when executed by at least one processor, cause an apparatus to at least establish a tunnel connection with a node in a private network, receive an initial packet from a network node, the initial packet being addressed to an internet protocol address of an apparatus and comprising an indicator indicating an identifier of the node in the private network, and start relaying of traffic between the node in the private network and the network node.

### INDUSTRIAL APPLICABILITY

At least some embodiments of the present invention find industrial application in enabling connectivity to a node that lacks a public address, such as for example a public internet protocol address.

### BRIEF DESCRIPTION OF THE DRAWINGS

FIG. 1 illustrates an example system capable of supporting at least some embodiments of the present invention;

FIG. 2 illustrates an example use case in accordance with at least some embodiments of the present invention;

FIG. 3 illustrates an example apparatus capable of supporting at least some embodiments of the present invention;

FIG. 4 illustrates signalling in accordance with at least some embodiments of the present invention;

FIG. 5 is a first flow chart of a first method in accordance with at least some embodiments of the present invention, and

FIG. 6 is a second flow chart of a second method in accordance with at least some embodiments of the present invention.

### DETAILED DESCRIPTION OF EXAMPLE EMBODIMENTS

By forming a tunnel to a relay node in a public network, a node in a private network may be enabled to perform a server function while retaining control of its cryptographic credentials. This increases security as a relay node is not enabled to inspect contents of communications between the node in the private network and network nodes it serves as the server function.

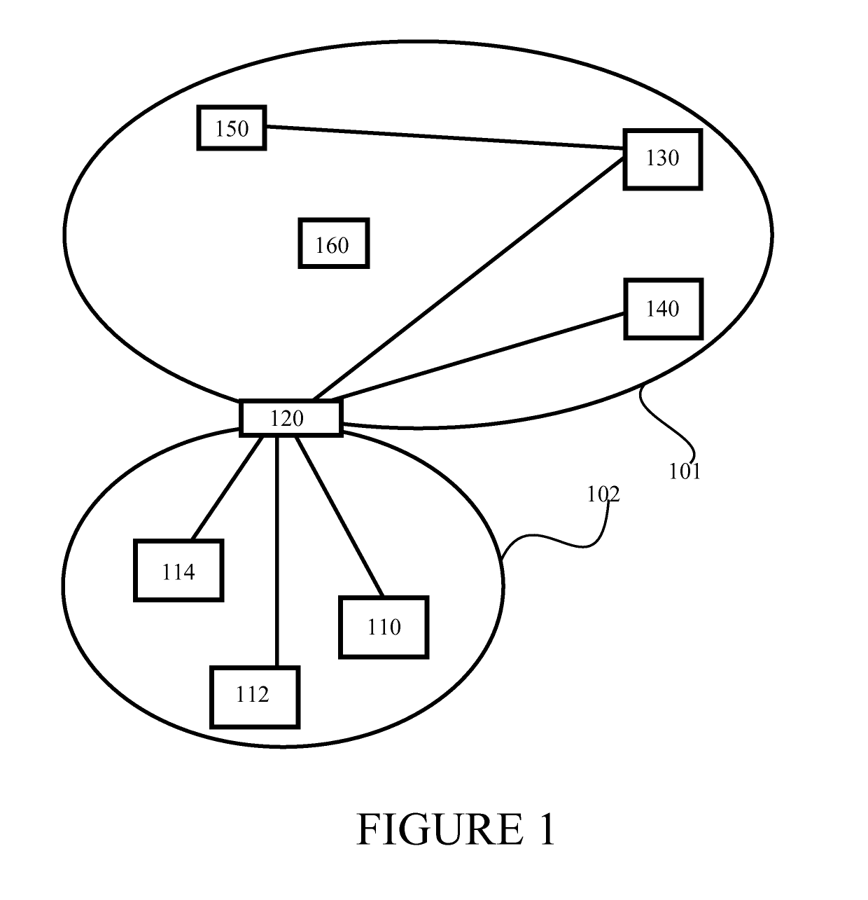

FIG. 1 illustrates an example system capable of supporting at least some embodiments of the present invention. FIG. 1 includes public network 101, which may comprise, for example the Internet. Public network 101 uses public IP addresses, and nodes comprised in public network may have globally valid, public, IP addresses. Network nodes 130 and 140 are nodes in public network 101, each having its own public IP address. At least one of network nodes 130 and 140 may comprise a gateway providing access to and from a private network.

Nodes 110, 112 and 114 are comprised in private network 102, each of them having a private address, which is valid in private network 102 but not in public network 101. At least one of nodes 110, 112 and 114 may comprise a consumer device, such as for example a home server or home data repository.

Gateway 120 is configured to provide access to and from private network 102. Gateway 120 has both a public address, by which it is accessible from public network 101, and a private address by which it is accessible from private network 102. In detail, a packet released into public network 101 with the public address of gateway 120 as a destination address will be routed by public network 101 to an interface of gateway 120 that is attached to public network 101. Likewise, a packet released into private network 102 with the private address of gateway 120 as a destination address will be routed by private network 102 to an interface of gateway 120 that is attached to private network 102.

A packet released into public network 101 with the private address of node 110 as a destination address will not be routed to node 110, since the private address of node 110 may be from the point of view of public network 101 a random address. The only node of private network 102 that has an address of public network 101 is gateway 120, and consequently gateway 120 is the only node of private network 102 that may be directly addressed from public network 101.

DNS server 150, disposed in public network 101, provides a service of mapping DNS names to IP addresses of public network 101. Network node 130, for example, may inquire from DNS server 150 the IP address of gateway 120 by transmitting to DNS server 150 a query, the query comprising a DNS name of gateway 120. Responsively, DNS server 150 may provide a response message to network node 130 that comprises the IP address, of public network 101, of gateway 120. Being in possession of the IP address of gateway 120, network node 130 may then compile a packet intended for gateway 120, place the IP address of gateway 120 as a destination address in the packet and release the packet to public network 101 for routing, which will cause the packet to be routed, based on the destination IP address, to gateway 120. DNS servers may provide a reverse query service, wherein the server will provide a DNS name as a response to a query comprising the IP address associated with the DNS name.

Node 114, for example, may communicate with node 140 via gateway 120. For example, node 114 may signal to gateway 120, internally in private network 102, to request gateway 120 to inquire from DNS server 150 the IP address of network node 140, wherein node 114 may provide a DNS name of network node 140 to gateway 120. Gateway 120 may responsively inquire the public IP address of network node 140 from DNS server 150, and provide it to node 114. Node 114 may then signal to gateway 120, again internally in private network 102, to initiate a connection to node 140 based at least in part on the public IP address of network node 140. Gateway 120 may then initiate network address translation, wherein gateway 120 will have a first connection, or session, based on private addressing of private network 102 with node 114, and a second connection based on public addressing of public network 101 with network node 140. Such a configuration may be known as network address translation, NAT. For example, gateway 120 may forward packets from network node 140 to node 114 based on a port of gateway 120 into which the packets are incoming from network node 140. In general, determining whether node 114 is behind a NAT may constitute determining whether node 114 is reachable from a public network.

Relay node 160, disposed in public network 101, may be configured to enable a node in private network 102 to act as a server. In principle, a node in public network 101 wishing to communicate with a node in private network 102 may transmit a packet to gateway 120, that packet comprising a predefined port number mapped to a private address within gateway 120, valid in private network 102, of the desired node in private network 102, to cause gateway 120 to forward the packet in private network 102 to the desired node. However, not all gateways allow mapping ports this way. Even if node 114 signals to DNS server 150 to associate the DNS name of node 114 with the public network address of gateway 120, the connection may not work if there is no port mapping available.

Node 114 may signal to relay node 160 to indicate to relay node 160 that node 114 is willing to provide a service. Node 114 may signal to DNS server 150 to obtain the address of relay node 160 as described above, or node 114 may be pre-configured with an address of relay node 160, for example. As a further alternative, node 114 may obtain the address of relay node 160 by querying it from gateway 120. Responsively, relay node 160 may signal to DNS server 150, which in FIG. 1 is representative of a DNS system comprising a plurality of DNS servers, to cause DNS server 150 to associate the DNS name of node 114 with a public address of relay node 160. Alternatively, node 114 itself may be configured to cause DNS server 150 to associate the DNS name of node 114 with a public address of relay node 160. In such a case, node 114 need not provide its DNS credentials to relay node 160. Node 114 may be configured to cause this association to occur by transmitting to DNS server 150 a message via gateway 120. After this, when a network node of public network 101 performs a DNS query with the DNS name of node 114, it will responsively receive a public address of relay node 160. In general, node 114 may provide a credential of itself, such as for example a password, to relay node 160 or DNS server 150. The credential may be used for updating information to a DNS system, for example. In some embodiments, DNS server 150 and relay node 160 may be co-hosted.

Responsive to receiving the signal from node 114 in private network 102, relay node 160 may participate in establishing a tunnel connection between node 114 and relay node 160. Since node 114 is in the private network, the tunnel connection traverses gateway 120 as described above in connection with NAT. The tunnel connection may be based on a suitable tunnelling technology, such as for example virtual private network, VPN, such as OpenVPN. Another example of a tunnelling technology is generic routing encapsulation, GRE.

To maintain the tunnel, keepalive packets may be periodically transmitted through the tunnel to prevent gateway 120 from determining a timeout condition with respect to a packet forwarding scheme between node 114 and relay node 160. Such a determination of timeout condition could break the tunnel, since in case gateway 120 would cease forwarding packets between node 114 and relay node 160, the tunnel could not operate. Keepalive packets may be transmitted by at least one of node 114 and relay node 160. In general a tunnel connection may be considered to be any data connection enabled to convey another connection through itself, wherein the another connection may comprise a protocol connection or a data stream. A data stream from relay node 160 may be constituted as a protocol connection in node 114. Also in such a case, it may be considered that relay node 160 forms a protocol connection to node 114 as it causes, but transmission of data, the forming of the protocol connection in node 114.

Node 114 may store a cryptographic certificate of itself, wherein the cryptographic certificate may be associated with the DNS name of node 114. The cryptographic certificate may comprise a cryptographic signature of a trusted party, such as for example the Federal Office of Information Security of the Federal Republic of Germany. The cryptographic certificate may comprise the DNS name and a public key of node 114. Node 114 may store, for example locally in node 114, a private key corresponding to the public key. A public key and private key that correspond to each other form a pair of public key cryptography keys. A public key may be used to encrypt information, which can be decrypted only by the private key corresponding to the public key. The public key is thus usable for encryption, but not decryption. A private key may be usable for performing cryptographic signing of information, wherein the validity of such a signature may be verified using the public key. In some embodiments, by inspecting the cryptographic certificate, a network node may verify the validity of the cryptographic signature of the trusted party to verify that the public key comprised in the certificate has been sent by the node identified by the DNS name comprised in the certificate, and that consequently only that node is able to decrypt, using the private key, information encrypted with the public key comprised in the certificate.

Assuming now network node 140 wants to access a server function performed by node 114, network node 140 may inquire from the DNS system for an address associated with the DNS name of node 114. As the DNS system has been caused to associate the DNS name of node 114 with an address of relay node 160, network node 140 is advised by the DNS system that the address of relay node 160 is the address of node 114. The address may be the public address of relay node 160.

Network node 140 may subsequently signal to relay node 160 in a bid to contact node 114. In general, network node 140 may include in at least one packet transmitted from network node 140 to relay node 160 an indication that identifies, directly or indirectly, node 114 as the intended communication counterparty. In detail, network node 140 may transmit an initial packet to relay node 160, the initial packet comprising a server name indication comprising, at least in part, the DNS name of node 114. The initial packet may comprise a client hello packet. The initial packet may be unencrypted.

Responsive to signalling from network node 140 identifying node 114, relay node 160 may establish protocol connections with network node 140 and node 114. The protocol connections may comprise transmission control protocol, TCP, connections, for example. Alternatively, real-time transport protocol, RTP, connections might be used, for example. A protocol connection from relay node 160 to node 114 may be established through a tunnel connection interconnecting relay node 160 and node 114, wherein the tunnel connection may be pre-existing. Subsequent to establishing the protocol connections, relay node 160 may relay packets between node 114 and network node 140 without manipulating the content payload of the packets being forwarded. The content payload may comprise contents of packets other than headers.

Once node 114 and network node 140 are communicatively coupled, via relay node 160, via the protocol connections, they may perform a cryptographic handshake with each other. The cryptographic handshake may take place transparently to relay node 160. The cryptographic handshake may comprise node 114 transmitting, to network node 140, a copy of its cryptographic certificate. Network node 140 may verify that the cryptographic certificate has a valid signature. Network node 140 may generate a session secret and encrypt it using a public key of node 114 that is comprised in the cryptographic certificate. Network node 140 may transmit the encrypted session secret to node 114. After node 114 has decrypted the session secret, using its private key, node 114 and network node 140 have a shared secret that may be used as an encryption key to secure a connection between network node 140 and node 114. Alternatively to using the session secret, a key derived from the session secret may be used. If a key derived from the session secret is used, the session is indirectly encrypted based on the session secret.

Since relay node 160 is not in possession of the private key of node 114, it cannot decrypt the session secret as it traverses relay node 160 on its way from network node 140 to node 114. Since subsequent communication between network node 140 and node 114 may be encrypted based, directly or indirectly, on the session secret, relay node 160 is also unable to access the contents of such subsequent communication. Thus, node 114 may be enabled to offer service to network nodes in public network 101 in such a way that relay node 160 is not enabled to gain access to the contents of information transmitted in connection with offering the service.

While relay node 160 relays packets between network node 140 and node 114, it may receive signals from network node 130 a bid to contact node 114. In general, network node 130 may include in at least one packet transmitted from network node 130 to relay node 160 an indication that identifies, directly or indirectly, node 114 as the intended communication counterparty. As described above in connection with network node 140, relay node 160 may responsively participate in establishing protocol connections to network node 130 and node 114 and start relaying between these two protocol connections. The protocol connection to node 114 may be routed via the tunnel connection, so the tunnel connection may convey a plurality of simultaneous protocol connections to node 114, each of the plurality of protocol connections being associated with a protocol connection to a different network node in the public network.

Relay node 160 may have a second tunnel connection, to a second node in a private network. In general relay node 160 may have a set of simultaneous tunnel connections, each tunnel connection being with a node in a private network, and each of the simultaneous tunnel connections may convey a plurality of simultaneous protocol connections. Relay node 160 may be configured to participate in a further plurality of protocol connections, each of the further plurality of protocol connections being associated with exactly one protocol connection being conveyed in one of the set of the tunnel connections. Each of the further plurality of protocol connections may connect relay node 160 with a network node in the public network. For each of the protocol connections in the set of tunnel connections, relay node 160 may be configured to relay traffic in both directions with the associated protocol connection among the further plurality of protocol connections.

A node in private network 102 may be configured to act as a relay node to further nodes in the private network, such as for example at least one of nodes 110 and/or 114. The private-network node may be enabled to do this in case it obtains a publicly routable address, that is, an address that is in accordance with the addressing of public network 101. In case node 112, for example, has a publicly routable address, node 114 may use it for relaying instead of using relay node 160.

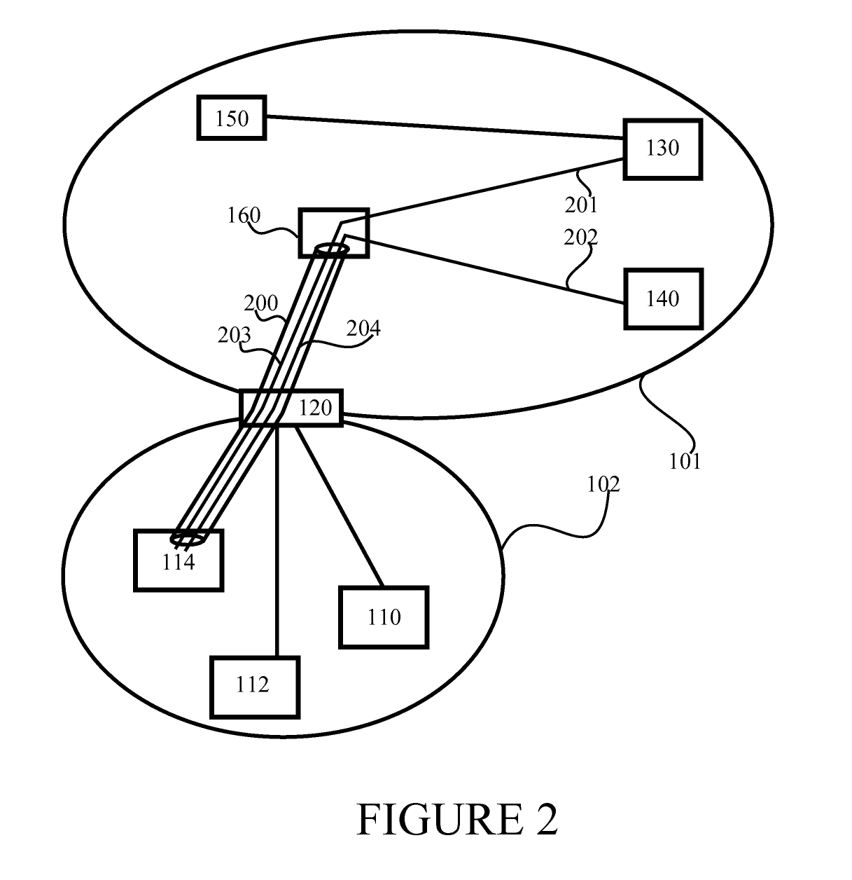

FIG. 2 illustrates an example use case in accordance with at least some embodiments of the present invention. Like reference numerals denote similar structure as in FIG. 1. FIG. 2 illustrates tunnel connection 200 interconnecting node 114 and relay node 160. Tunnel connection 200 traverses gateway 120.

Network node 130 has a protocol connection 201 with relay node 160, and relay node 160 has a protocol connection 203 with node 114. Relay node 160 is arranged to relay packets between protocol connections 201 and 203, to effectively couple communicatively node 114 with network node 130. Network node 140 has a protocol connection 202 with relay node 160, and relay node 160 has a protocol connection 204 with node 114. Relay node 160 is arranged to relay packets between protocol connections 202 and 204, to effectively couple communicatively node 114 with network node 140.

Relay node 160 may be configured to, responsive to detecting that protocol connection 203 is closed by node 114, close protocol connection 201. Relay node 160 may be configured to, responsive to detecting that protocol connection 202 is closed by network node 140, close protocol connection 204.

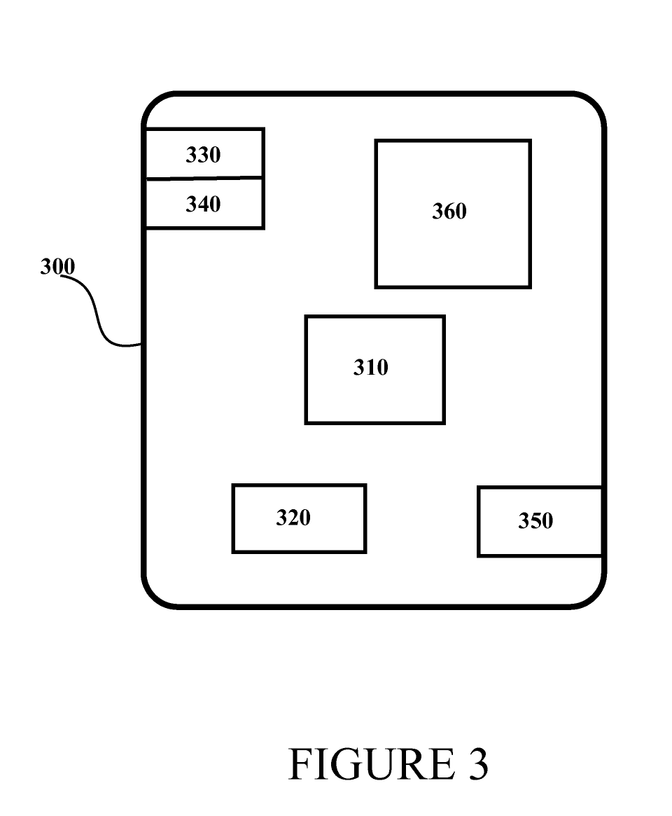

FIG. 3 illustrates an example apparatus capable of supporting at least some embodiments of the present invention. Illustrated is device 300, which may comprise, for example, node 114 or relay node 160 of FIG. 1 or FIG. 2. Comprised in device 300 is processor 310, which may comprise, for example, a single- or multi-core processor wherein a single-core processor comprises one processing core and a multi-core processor comprises more than one processing core. Processor 310 may comprise a Qualcomm Snapdragon 800 processor, for example. Processor 310 may comprise more than one processor. A processing core may comprise, for example, a Cortex-A8 processing core manufactured by Intel Corporation or a Brisbane processing core produced by Advanced Micro Devices Corporation. Processor 310 may comprise at least one application-specific integrated circuit, ASIC. Processor 310 may comprise at least one field-programmable gate array, FPGA. Processor 310 may be means for performing method steps in device 300. Processor 310 may be configured, at least in part by computer instructions, to perform actions.

Device 300 may comprise memory 320. Memory 320 may comprise random-access memory and/or permanent memory. Memory 320 may comprise at least one RAM chip. Memory 320 may comprise magnetic, optical and/or holographic memory, for example. Memory 320 may be at least in part accessible to processor 310. Memory 320 may be means for storing information. Memory 320 may comprise computer instructions that processor 310 is configured to execute. When computer instructions configured to cause processor 310 to perform certain actions are stored in memory 320, and device 300 overall is configured to run under the direction of processor 310 using computer instructions from memory 320, processor 310 and/or its at least one processing core may be considered to be configured to perform said certain actions.

Device 300 may comprise a transmitter 330. Device 300 may comprise a receiver 340. Transmitter 330 and receiver 340 may be configured to transmit and receive, respectively, information in accordance with at least one cellular or non-cellular standard. Transmitter 330 may comprise more than one transmitter. Receiver 340 may comprise more than one receiver. Transmitter 330 and/or receiver 340 may be configured to operate in accordance with Ethernet, wideband code division multiple access, WCDMA, long term evolution, LTE, IS-95, wireless local area network, WLAN, Ethernet and/or worldwide interoperability for microwave access, WiMAX, standards, for example.

Device 300 may comprise a near-field communication, NFC, transceiver 350. NFC transceiver 350 may support at least one NFC technology, such as NFC, Bluetooth, Wibree or similar technologies.

Device 300 may comprise user interface, UI, 360. UI 360 may comprise at least one of a display, a keyboard, a touchscreen, a vibrator arranged to signal to a user by causing device 300 to vibrate, a speaker and a microphone. A user may be able to operate device 300 via UI 360, for example to configure device 300 to act as a server or to perform a server function.

Processor 310 may be furnished with a transmitter arranged to output information from processor 310, via electrical leads internal to device 300, to other devices comprised in device 300. Such a transmitter may comprise a serial bus transmitter arranged to, for example, output information via at least one electrical lead to memory 320 for storage therein. Alternatively to a serial bus, the transmitter may comprise a parallel bus transmitter. Likewise processor 310 may comprise a receiver arranged to receive information in processor 310, via electrical leads internal to device 300, from other devices comprised in device 300. Such a receiver may comprise a serial bus receiver arranged to, for example, receive information via at least one electrical lead from receiver 340 for processing in processor 310. Alternatively to a serial bus, the receiver may comprise a parallel bus receiver.

Device 300 may comprise further devices not illustrated in FIG. 3. For example, where device 300 comprises a smartphone, it may comprise at least one digital camera. Some devices 300 may comprise a back-facing camera and a front-facing camera, wherein the back-facing camera may be intended for digital photography and the front-facing camera for video telephony. Device 300 may comprise a fingerprint sensor arranged to authenticate, at least in part, a user of device 300. In some embodiments, device 300 lacks at least one device described above. For example, some devices 300 may lack a NFC transceiver 350.

Processor 310, memory 320, transmitter 330, receiver 340, NFC transceiver 350, UI 360 may be interconnected by electrical leads internal to device 300 in a multitude of different ways. For example, each of the aforementioned devices may be separately connected to a master bus internal to device 300, to allow for the devices to exchange information. However, as the skilled person will appreciate, this is only one example and depending on the embodiment various ways of interconnecting at least two of the aforementioned devices may be selected without departing from the scope of the present invention.

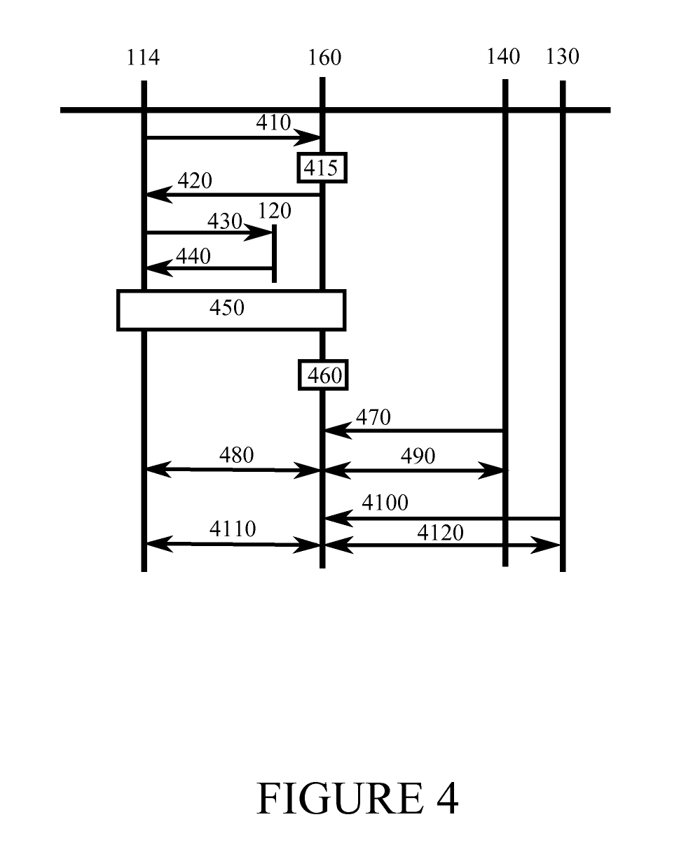

FIG. 4 illustrates signalling in accordance with at least some embodiments of the present invention. On the vertical axes are disposed, from left to right, node 114, relay node 160, network node 140 and network node 130. Time advances from the top toward the bottom.

In optional phase 410, node 114 transmits a packet to query its IP address, the packet being addressed to a node in a public network, such as for example relay node 160. In optional phase 415, relay node 160 may be configured to attempt to establish an inbound connection to node 114 and to make a record concerning whether the attempt succeeds. In response, in phase 420, node 114 receives a packet which comprises the IP address of node 114 from the point of view of the node in the public network. In case the address in the packet differs from an address node 114 has, node 114 may conclude it is behind a NAT and the address node 114 has is a private address of a private network. In embodiments where phase 410 is absent, also phase 420 is absent. In embodiments where phase 415 is present, phase 420 may comprise that relay node 160 informs node 114 whether the attempt of phase 115 was successful.

In optional phase 430, node 114 attempts to open a universal plug and play, UPnP, port in the NAT, and in phase 440 node 114 is informed this UPnP is not available. Phases 430 and 440, where present, occur between node 114 and gateway 120. As a response, node 114 resolves to employ tunnelling via relay node 160 to offer a server service to the public network. In case node 114 had a public address, using a relay node would not be necessary since node 114 could be addressed directly from the public network. In embodiments where phase 430 is absent, also phase 440 is absent.

In phase 450, node 114 forms, together with relay node 160, a tunnel connection between node 114 and relay node 160. Forming the tunnel connection may comprise node 114 providing to relay node 160 at least one of a DNS name of node 114, and at least one credential, wherein the at least one credential may comprise a password. The at least one credential may be preconfigured in node 114. The at least one credential may be associated with a specific DNS domain name of node 114. Although illustrated as a rectangular box specific to phase 450, the tunnel connection continues in time and is not torn down as processing advances to phase 460.

In phase 460, relay node 160 causes the DNS system to associate the DNS name of node 114 with an address of relay node 160. The address of relay node 160 may comprise a public IP address. Relay node 160 may use the at least one credential provided in phase 450 in updating the association in the DNS system. Also in phase 460, relay node 160 may store a mapping of the DNS name of node 114 to an identifier of the tunnel connection established in phase 450.

In phase 470, relay node 160 receives, from network node 140, at least one packet indicating node 114 as an intended communication counterpart. For example, at least one of the at least one packets may comprise an identifier of node 114, such as for example the DNS name of node 114. The identifier may comprise a server name indication, SNI, identifier, for example. The SNI may contain the DNS name of node 114.

Responsive to phase 470, relay node 160 may participate in establishing protocol connections with node 114 and network node 140, wherein the protocol connection with node 114 may be conveyed via the tunnel connection established in phase 450. These are illustrated as phases 480 and 490. Relay node may thereafter relay packets received from the protocol connection it has with network node 140 to the protocol connection it has with node 114, and vice versa. Node 114 and network node 140 may complete a cryptographic handshake via the protocol connections, for example, and subsequently engage in an encrypted session. Relay node 160 may be unable to determine the contents of the encrypted session. Relay node 160 is, however, able to relay encrypted packets between node 114 and network node 140, via the respective protocol connections.

In phase 4100, relay node 160 receives, from network node 130, at least one packet indicating node 114 as an intended communication counterpart. In phases 4110 and 4120, relay node 160 may participate in establishing protocol connections and relaying as described immediately above in connection with phases 480 and 490. The tunnel connection established in phase 450 may convey both the protocol connection established in phase 480 and the protocol connection established in phase 4110. A communication capacity of the tunnel connection may be shared between the protocol connections conveyed via it.

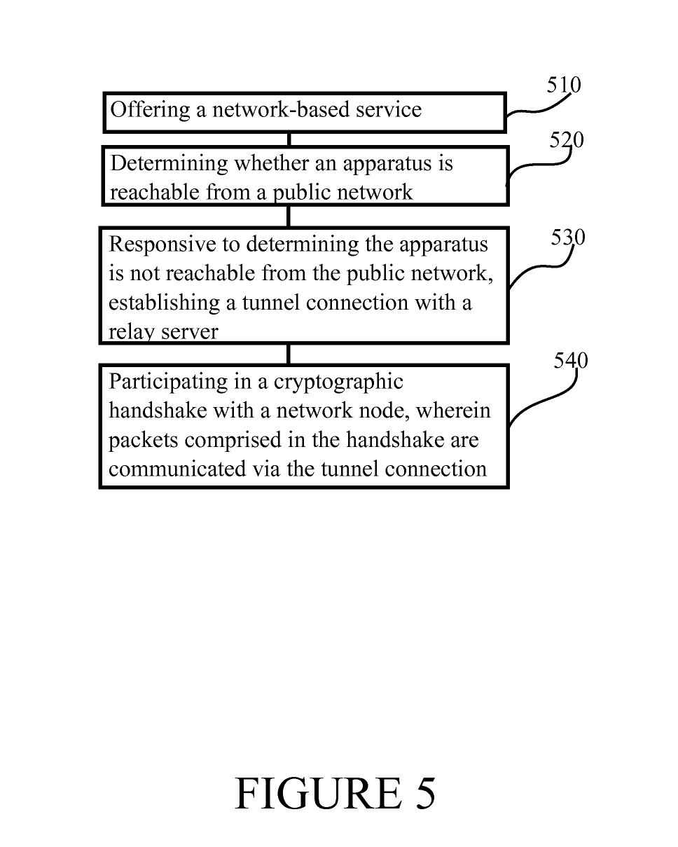

FIG. 5 is a first flow chart of a first method in accordance with at least some embodiments of the present invention. The phases of the illustrated method may be performed in node 114 or in a control device configured to control the functioning of node 114, for example. Phase 510 comprises offering a network-based service. Phase 520 comprises determining whether an apparatus is reachable from a public network. The apparatus may comprise an apparatus performing the method. Phase 530 comprises, responsive to determining the apparatus is not reachable from the public network, establishing a tunnel connection with a relay server. Finally, phase 540 comprises participating in a cryptographic handshake with a network node, wherein packets comprised in the handshake are communicated via the tunnel connection. The method may further comprise storing a private key associated with a public key, the public key being comprised in a cryptographic certificate stored in the apparatus. Participating in the cryptographic handshake may comprise decrypting a session secret with the private key.

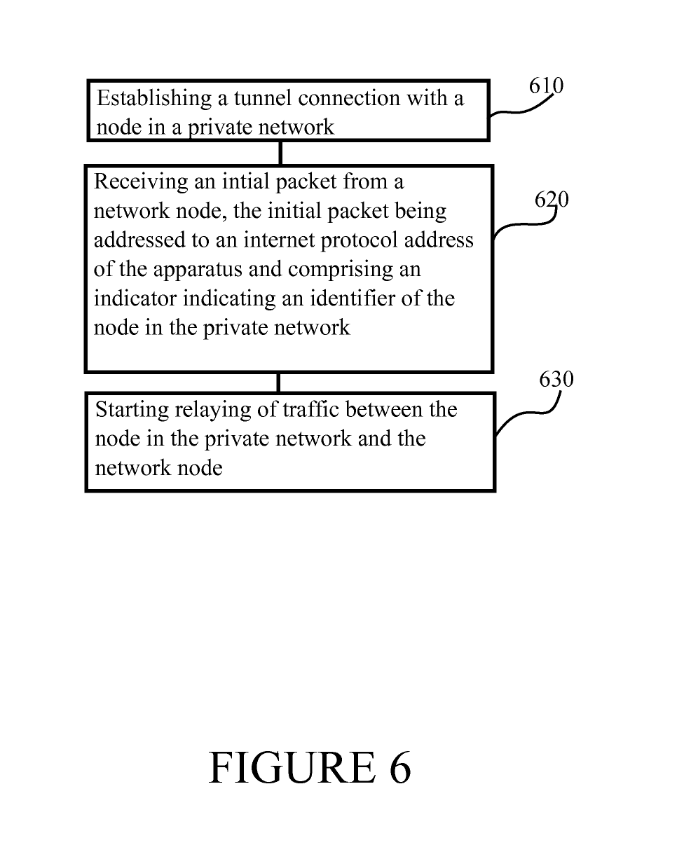

FIG. 6 is a second flow chart of a second method in accordance with at least some embodiments of the present invention. The phases of the illustrated method may be performed in relay node 160 or in a control device configured to control the functioning of relay node 160, for example.

Phase 610 comprises establishing a tunnel connection with a node in a private network. Phase 620 comprises receiving an initial packet from a network node, the initial packet being addressed to an internet protocol address of an apparatus and comprising an indicator indicating an identifier of the node in the private network. The apparatus may comprise the apparatus performing the method. The identifier may comprise the domain name system name of the node in the private network. Finally, phase 630 comprises starting relaying of traffic between the node in the private network and the network node.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1-34. (canceled)

35. An apparatus comprising at least one processing core, at least one memory including computer program code, the at least one memory and the computer program code being configured to, with the at least one processing core, cause the apparatus at least to:
offer a network-based service;
determine whether the apparatus is reachable from a public network;
responsive to determining the apparatus is not reachable from the public network, establish a tunnel connection with a relay server, and
participate in a cryptographic handshake with a network node, wherein packets comprised in the handshake are communicated via the tunnel connection.

36. The apparatus according to claim 35, wherein the network-based service is associated with a domain name system name, and the apparatus stores a cryptographic certificate associated with the domain name system name and the cryptographic handshake is based at least in part on the cryptographic certificate.

37. The apparatus according to claim 35, wherein the at least one memory and the computer program code are configured to, with the at least one processing core, cause the apparatus to provide the network-based service to the network node after the cryptographic handshake is successfully completed.

38. The apparatus according to claim 35, wherein the cryptographic handshake comprises a transport layer security handshake.

39. The apparatus according to claim 35, wherein determining whether the apparatus is reachable from a public network comprises requesting an internet protocol address of the apparatus.

40. The apparatus according to claim 35, wherein the network-based service comprises a web service.

41. The apparatus according to claim 35, wherein the tunnel connection comprises a virtual private network tunnel connection.

42. The apparatus according to claim 41, wherein establishing the tunnel connection comprises providing credentials of the apparatus to the relay node.

43. The apparatus according to claim 35, wherein the apparatus is configured to cause a domain name system name of the apparatus to become associated with an address of the relay server.

44. A method, comprising:
offering a network-based service;
determining whether an apparatus is reachable from a public network;
responsive to determining the apparatus is not reachable from the public network, establishing a tunnel connection with a relay server, and
participating in a cryptographic handshake with a network node, wherein packets comprised in the handshake are communicated via the tunnel connection.

45. The method according to claim 44, wherein the network-based service is associated with a domain name system name, and the method comprises storing a cryptographic certificate associated with the domain name system name and the cryptographic handshake is based at least in part on the cryptographic certificate.

46. The method according to claim 44, wherein the method further comprises providing the network-based service to the network node after the cryptographic handshake is successfully completed.

47. The method according to claim 44, wherein the cryptographic handshake comprises a transport layer security handshake.

48. The method according to claim 44, wherein determining whether the apparatus is reachable from a public network comprises requesting an internet protocol address of the apparatus.

49. The method according to claim 44, wherein the network-based service comprises a web service.

50. The method according to claim 44, wherein the tunnel connection comprises a virtual private network tunnel connection.

51. The method according to claim 50, wherein establishing the tunnel connection comprises providing credentials of the apparatus performing the method to the relay node.

52. A non-transitory computer readable medium having stored thereon a set of computer readable instructions that, when executed by at least one processor, cause an apparatus to at least:
offer a network-based service;
determine whether the apparatus is reachable from a public network;
responsive to determining the apparatus is not reachable from the public network, establish a tunnel connection with a relay server, and
participate in a cryptographic handshake with a network node, wherein packets comprised in the handshake are communicated via the tunnel connection
